(19) United States
(12) Patent Application Publication
(10) Pub. No.: US 2026/0156457 A1
(43) Pub. Date: Jun. 4, 2026

(54) WIRELESS ACCESS POINT AND CONTROL SYSTEM

(71) Applicant: WESCO Distribution, Inc., Pittsburgh, PA (US)

(72) Inventors: Gabriel DAHER, Knoxfield (AU); Brett D’ELTON, Knoxfield (AU); Steve MITCHELL, Knoxfield (AU)

(73) Assignee: WESCO Distribution, Inc., Pittsburgh, PA (US)

(21) Appl. No.: 19/161,058

(22) PCT Filed: Dec. 4, 2024
(86) PCT No.: PCT/US2024/058512

§ 371 Date: Aug. 29, 2025

(51) Int. Cl. H04W 8/24

(52) U.S. Cl. CPC H04W 8/24

(57) ABSTRACT

An access control system including a system controller and a wireless access point is disclosed. A wireless transmitter of the system controller transmits data over a long-range wireless communication protocol. An access control database defines an access schedule for authorised users at a plurality of access points. The wireless access point includes a wireless receiver to receive data over the wireless communication protocol, and a locally stored schedule data structure, storing a local access schedule for authorised users at the wireless access point. The system controller identifies a change in the access control database, analyses the change to determine whether it affects the local access schedule for the wireless access point, and transmits forward access schedule data to the wireless access point reflecting the change based on necessity. The wireless access point then updates the locally stored access schedule data structure, in accordance with the forward access schedule data.

### TECHNICAL FIELD

The present disclosure pertains to a wireless access control system, and various embodiments described in the present disclosure include a wireless access point, a controller, and associated methods of operation.

### BACKGROUND

Any discussion of the prior art throughout the specification should in no way be considered as an admission that such prior art is widely known or forms part of the common general knowledge in the field.

The advent of wireless technology has significantly transformed the access control industry, making wireless locks increasingly popular due to their convenience and flexibility.

Early wireless locks primarily used RF (Radio Frequency) technology. As Bluetooth and ZigBee technologies matured, these communication protocols were integrated into wireless locks, allowing for better connectivity and also allowing control through smartphones and other devices. In recent years, Wi-Fi-enabled locks have become popular, offering remote access and control through internet connectivity. Modern wireless locks are often integrated into smart home systems, working in conjunction with other IoT (Internet of Things) devices.

Different operational techniques have been deployed in wireless locks over the years. Early wireless locks used RF technology to grant access based on proximity. An RF transmitter in a key fob or card would communicate with the lock to unlock it. However, RF technology had limited range and was susceptible to interference from other electronic devices.

Bluetooth technology allowed users to control access using their smartphones. This technology provided better security and ease of use compared to RF. Despite its advantages, Bluetooth has a limited range, typically around ten metres, which restricts its use in larger installations.

ZigBee technology operates on a mesh network, allowing multiple devices to communicate with each other and extend the range of the network. ZigBee is known for its low power consumption, making it suitable for battery-operated locks. However, while efficient in power usage, ZigBee has limited transmission range and requires always powered nodes to address the limited range issues. These always powered nodes negate the benefits of a battery-operated system.

Wi-Fi-enabled locks provide remote access and control through internet connectivity, allowing users to monitor and control their locks from anywhere. Wi-Fi supports higher data rates, enabling more complex operations and features. However, Wi-Fi consumes more power compared to Bluetooth and ZigBee, leading to more frequent battery replacements.

Despite their advancements, existing wireless lock systems face several disadvantages. Technologies like Bluetooth and ZigBee have a limited range, typically around 10 metres for Bluetooth and slightly more for ZigBee in a mesh network. This range is insufficient for large-scale installations like commercial buildings or sprawling residential properties. While Wi-Fi offers better range, it still requires a robust network of routers and extenders to cover large areas, which can be costly and complex to manage.

Technologies like Bluetooth and ZigBee have limited bandwidth, making it challenging to handle large volumes of data or complex operations efficiently. High data transmission rates increase power consumption, leading to reduced battery life. Frequent battery replacements are inconvenient and increase maintenance costs. Wireless signals are also prone to interference from other electronic devices and physical obstructions, which can disrupt communication and affect the reliability of the lock system.

Overall, wireless access control locks have become increasingly popular due to their convenience and flexibility. However, common communication technologies used in these systems, such as Bluetooth, ZigBee, and Wi-Fi, provide relatively high bandwidth but are limited by their short operational range. The issue with mesh networks requiring always-on nodes is that it leads to increased power consumption, reduced battery life, and necessitates extended UPS time to meet security standards. These technologies require the locks to be within close proximity (typically within ten metres) of an access door controller, which is a significant limitation for large-scale installations. Additionally, maintaining long battery life while ensuring reliable communication remains a challenge.

Therefore, there is a need to identify a solution for overcoming the challenges posed by the current solutions.

### SUMMARY

In various embodiments, the present disclosure provides a system and method for overcoming the challenges with the prior art solutions.

In a first embodiment, there is provided an access control system comprising:
a system controller; and
a wireless access point,
wherein the system controller is configured to:
   identify and analyse changes in a locally stored access schedule for the wireless access point; and
   in response to a detected change meeting certain criteria, transmit a forward access schedule data packet to the wireless access point,
and wherein the wireless access point is configured:
   in response to receiving the forward access schedule data from the system controller, update the locally stored access schedule data structure.

In a second embodiment, there is provided a wireless access point comprising:
at least one wireless receiver to receive data over the wireless communication protocol; and
a locally stored schedule data structure, storing a local access schedule for authorised users at the wireless access point; and
a processor configured to:
   receive forward access schedule data from a system controller via the wireless receiver; and
   update the locally stored access schedule data structure, in accordance with the forward access schedule data.

In a third embodiment, there is provided a system controller for an access control system comprising:
at least one wireless transmitter to transmit data over a wireless communication protocol;
an access control database defining an access schedule for authorised users at a plurality of access points; and
at least one processor configured to:
   identify a change in the access control database;
   analyse the change to determine whether it affects the local access schedule for a wireless access point; and
   transmit forward access schedule data to the wireless access point reflecting the change, via the at least one wireless transmitter, based on the change affecting the wireless access point.

The wireless access control point may further comprise a reader to read a user identification of a requesting user, for example a short-range wireless reader such as an NFC or RFID card reader. The processor of the wireless access point may further be configured to compare the user identification to the access schedule in the locally stored schedule data structure 250, to determine whether to permit access to the requesting user.

The wireless access control point may further comprise a lock having a locked state and an unlocked state. The processor of the wireless access point may be further configured to set the lock to the unlocked state based on the associated user being permitted access. The lock may comprise an electro-mechanical lock. The lock may comprise a locking member slidable into a recess to move the lock to the locked state, and out of the recess to move the lock into the unlocked state. The lock may further comprise a biasing element to bias the locking member into the recess. The lock may further comprise an actuator to drive the locking member out of the recess, when access is granted to a requesting user.

The access schedule in the locally stored schedule data structure 250 may comprise a schedule of time periods during which each authorised user is permitted access. Determining whether to permit access to the requesting user may accordingly comprise determining a current time and checking the access schedule for the requesting user at the current time.

The forward access schedule data is preferably transmitted and received in a compressed form. This assists both the wireless access point and the system controller to stay within a bandwidth allocation. In some cases, the bandwidth allocation may be 1% of airtime. The wireless communication protocol may be a long-range wireless communication protocol, such as LoRA or SigFox.

In a compressed form, the forward access schedule data may comprise a derived ID to identify an associated authorised user, and a forward user schedule encoding a change in permitted access times for the associated authorised user. The derived ID may be a unique ID for the associated user, which is shorter than the user identification read by the reader. The forward user schedule may comprise a start or stop indicator (which may be a single bit), and a time indicator specifying particular access times. Accordingly, the forward user schedule may indicate whether access for the association authorised user starts or stops at the particular times. This may be provided in the form of (i) a bit mask representing days of the week, (ii) an hour indicator, and (iii) a minute indicator, which can allow the forward access schedule to comprise four bytes or less. In preferred embodiments, the forward access schedule comprises three bytes or less.

In other embodiments, there is provided a wireless access point comprising:
at least one wireless transmitter to transmit data over the wireless communication protocol; and
a locally stored access event log to record access events at the wireless access point; and
a processor configured to:
   record access events in the locally stored access event log; and
   transmit the access event log to the system controller, over the wireless communication protocol.

In one embodiment, the access event log is transmitted asynchronously. That is, the access event log is transmitted distinctly, or at a different time from, the access events themselves. This enables the wireless access point to better control the amount of data transmitted over the wireless communication protocol. This can be particularly important where the wireless communication protocol is a long-range wireless communication protocol, which may have regulations limiting a device's bandwidth allocation. In relation to this embodiment (which may be combined with previous embodiments), the system controller may further comprise a wireless receiver to receive the access event log over the wireless communication protocol. Access events include occurrences related to the use and monitoring of the wireless access point. For example, access events can include successful authentications or failed authentication attempts. In some embodiments, access events stored in the access event log may include other event types, such as attempts to force access (e.g. an attempt to open a door without authentication), occasions when a door is held open (e.g. for longer than a permitted time), tailgating detection (e.g. in circumstances where only a single person is authorised for access through a door, but another visitor follows closely behind without authentication), tampering alerts, emergency override activation (e.g. in the event of a fire alarm), lockdown activation (e.g. if an access point is locked down by a site manager). Many of the above event types could be associated with security breaches. However, it will be appreciated that the particular events logged will depend on the particular site and function of the wireless access point, and different wireless access points may be configured to record different access events.

In another embodiment, there is provided a method for operating an access control system, comprising:
analysing, by a system controller, access schedule data for at least one authorised user for a wireless access point;
calculating, by the system controller, the next change in the authorised user's access schedule;
preparing, by the system controller, forward access schedule data for the at least one authorised user for the wireless access point; and
transmitting, by the system controller, the forward access schedule data to the wireless access point, over a wireless transmission protocol.

In another embodiment, there is provided a method for operating an access control system, comprising:
storing, by a wireless access point, a record of access events in an access event log; and
monitoring, by the wireless access point, the amount of data transmitted over a long-range wireless communication protocol; and
transmitting, by the wireless access point, the access event log to a system controller, over the wireless communication protocol,
wherein the transmitting of the access event log is timed to stay within a bandwidth allocation for the wireless access point.

The access event log may be a compressed representation of time and date for each access event.

The method may further comprise reconstructing, by the system controller, an event chronology at the access based on the received access event log.

Further embodiments include a wireless access point to facilitate the above methods, and a system controller to facilitate the above methods

In each of the above aspects, at least the wireless access point may be battery powered. Accordingly, the various embodiments described in the present disclosure provide methods, systems and apparatus for extending the range and reducing the power consumption of wireless access points by utilising compressed data structures to manage and transmit access permissions.

Various embodiments described in the present disclosure address limitations in conventional wireless access control systems by reducing the need for multiple devices to relay signals, thus reducing overall power consumption and battery drain. The disclosed embodiments facilitate direct, dedicated connections between two points, to provide efficient use of power and potentially minimizing the requirement for extended UPS time to meet security standards. This alleviates the issue of always-on nodes in mesh networks by eliminating the need for multiple devices to constantly relay signals, thus reducing overall power consumption and battery drain. In turn, this can potentially reduce the requirement for extended UPS time to meet security standards. The various embodiments described in present disclosure may be able to significantly extend the operational range of wireless access points to reduce installation, operational and maintenance costs.

It will be appreciated that, unless otherwise stated, details and variations described for one embodiment equally apply to other embodiments.

The following provides a detailed description of one or more embodiments, along with figures that illustrate their principles by example. Although these embodiments are described below, the overall scope is not limited to any one embodiment. Instead, the scope is defined the appended claims, which include various alternatives, modifications, and equivalents. To illustrate this, specific details are to give a comprehensive understanding of the disclosure.

The embodiments described below may be practised according to the claims without some or all these specific details. For clarity, technical material that is known in the technical fields related to this disclosure has not been described in detail so that the present invention is not unnecessarily obscured.

### BRIEF DESCRIPTION OF THE DRAWINGS

Various embodiments will now be described by way of example only with reference to the accompanying drawings.

FIG. 1 is a diagram of a wireless access point system according to an embodiment of the present disclosure.

FIG. 2 is a flowchart depicting a method of generating and synchronising a derived ID, according to an embodiment of the present disclosure.

FIG. 3 is a flowchart depicting a method of granting or denying access, according to an embodiment of the present disclosure.

FIG. 4 is a flowchart depicting a method of transmitting forward schedule access data, according to an embodiment of the present disclosure.

FIG. 5 is a flowchart depicting a method performed by a system controller, according to an embodiment of the present disclosure.

FIG. 6 is a flowchart depicting a method performed by a wireless access point, according to a method of an embodiment of the present disclosure.

FIG. 7 is a flowchart depicting a method performed taken by a wireless access point, according to an embodiment of another aspect of the present disclosure.

### DESCRIPTION

In various embodiments, the present disclosure utilises long-range, low-power wireless communication technology, suitable for environments requiring extensive coverage with minimal infrastructure. This is achieved by implementing a low data rate wireless link, which, despite its limitations, provides sufficient functionality for access control purposes when combined with an end-to-end data compression and encoding schema as defined in this specification.

Unless defined otherwise, all technical and scientific terms used herein have the same meaning as commonly understood by one of ordinary skill in the art in this technical field. Although any methods and materials similar or equivalent to those described herein can also be used in the practice or testing of the various embodiments described in the present disclosure, a limited number of the exemplary methods and materials are described herein.

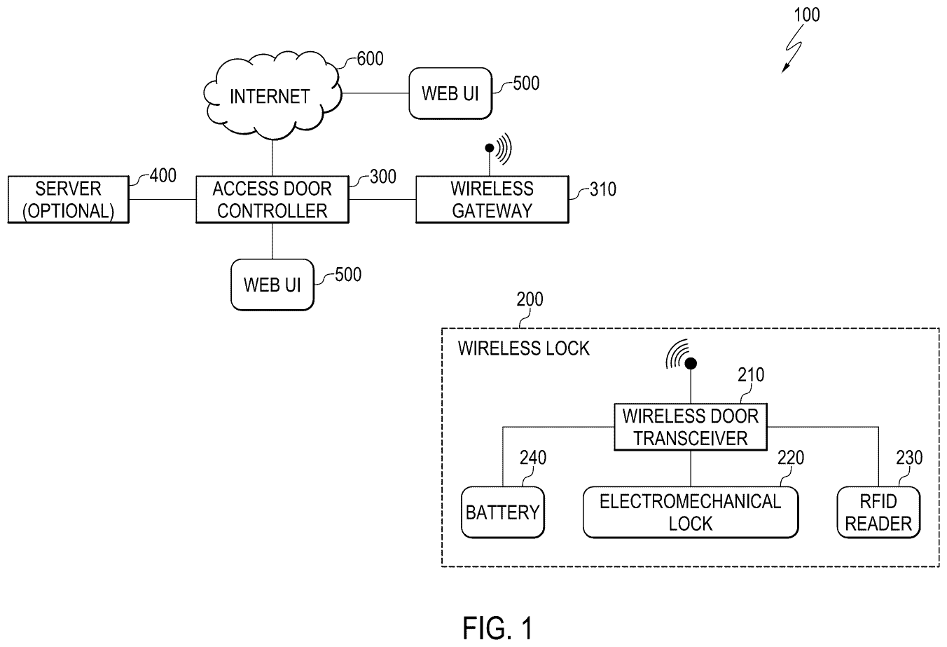

Referring to FIG. 1, there is depicted an access control system 100 according to an embodiment of the present disclosure. The access control system 100 comprises a wireless access point, in the form of a wireless access control lock 200, and a system controller 300. The system controller 300 may be in communication with a separate server 400, as depicted in FIG. 1, and may be managed through a web user interface (WebUI) 500 accessed via the Internet 600.

The wireless lock 200 comprises a wireless transceiver 210, which acts as both a wireless transmitter and a wireless receiver. In this embodiment, the wireless transceiver is configured to transmit and receive over a long-range wireless communication protocol, such as LoRA or SigFox. In different embodiments, other long-range communication protocols may be utilised.

The wireless lock 200 also comprises an electromagnetic lock 220, which can be used to lock or unlock a door (by moving between a locked state and an unlocked state, as directed by a processor of the wireless access control lock 200). The electromagnetic lock 220 may include a locking member that can slide into and out of a recess at the access point, to selectively lock or unlock a door or other point of access.

The wireless lock 200 further comprises a reader 230, which in this embodiment is an RFID reader. The RFID reader can be used to read an RFID card associated with a user requesting access at the wireless access point 200. Of course, in alternative embodiments, other technologies may be used for user identification, including other short range wireless communication networks. By way of example, in alternative embodiments, the reader could be an NFC reader, or may also be a Bluetooth, ZigBee or WiFi reader.

Also shown is a battery 240 which powers the wireless access point 200. As the wireless access point 200 is battery-powered in this embodiment, it avoids the need for it to be connected to a power source via a power cable. This provides a significant advantage when installing the wireless access point 200, as power cables and infrastructure do not need to be installed. However, this also means that battery life is an important consideration for the wireless access point 200, and several features of the present disclosure (described in detail later in this specification) are directed to decreasing the transmission requirements of the system, to prolong the battery life of the wireless access point 200.

To reduce the transmission requirements, the wireless access point also comprises a locally stored schedule data structure 250, which stores an access schedule for authorised users at the wireless access point. Specifically, the schedule data structure includes information about which users are permitted to pass through the access point, at which times. Further details of the schedule data structure are described later in this specification.

Turning now to the system/access controller 300, this comprises a wireless gateway 310 to both transmit and receive data over the wireless communication protocol. The access controller 300 may also be in communication with a server 400 (optional). A user may interact with the controller 300 via the WebUI 500. The controller 300 is provided with access to an access control database 320, which may be stored on the controller 300 itself, on the server 400, or on another cloud device.

The access control database 320 defines an access schedule for all authorised users at the site. This may include user identifications (e.g. card IDs) associated with a particular authorised user, and a timetable for each authorised user setting out when they are permitted access to the site, and through which access points. For large sites, there could be a significant number of access points, and different users may only be permitted to access different parts of the sites, within different times.

The WebUI 500 may enable a site manager to add or remove authorised users, to update their access timetables for different access points, and to review event logs for each access point-for example, instances where a user has attempted to access through a particular access point, and whether access was granted or denied. Event logs may also include unauthorised attempts to breach an access point (for example, based on the system detecting an attempt to breach a door) and may include faults logged at a particular access points. Event logs may include low battery indications for a wireless access point.

The present disclosure utilises a number of techniques to reduce the amount of data required to be transmitted between the wireless access point 200 and the system controller 300. In particular, the system of this embodiment (i) compresses user identifications by creating a “derived ID” for each user, (ii) creates a “forward schedule” for transmission from the controller 300 to the wireless access point 200, to update the locally stored schedule data structure 250 as and when required, and (iii) transmits an access event log as a “post schedule” from the wireless access point 200 to the controller 300, asynchronously from the actual events.

The aim is to minimise the data needed to be transmitted between the wireless access point 200 and the controller 300. Firstly, this reduces the energy consumption of the wireless access point 200, as less transmission is required. Secondly, this helps the system 100 comply with regulatory requirements for long-range wireless communication protocols. For instance, regulatory requirements may specify that a device operating on a particular long-range wireless communication protocol may only take up 1% of the available airtime/duty time. Other bandwidth allocations may be specified, depending on the particular regulatory environment and the particular wireless communication protocol used. By reducing the amount of data transmitted and transmitting it asynchronously with user requests-either ahead of time (forward schedule) or after events (post schedule), the present disclosure allows the system 100 to better monitor its compliance with bandwidth allocations.

In the context of the present disclosure, a Derived ID is a compressed data and encoding schema structure representing a credential holder's unique identifier. This Derived ID is truncated and verified for uniqueness across the system. The truncation reduces the data size, making it feasible to transmit over a low data rate link while ensuring each credential holder can be uniquely identified.

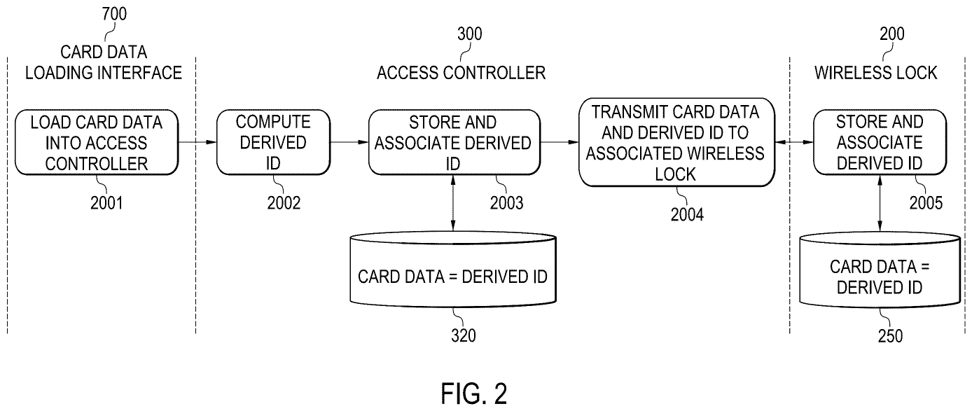

FIG. 2 depicts the process of loading card data into the system 100, and generating Derived IDs. To generate a Derived ID, the authorised user's card data is read via a card data loading interface 700, and loaded 2001 into access controller 300, as shown in FIG. 2. Typically, user identifications on a card are larger than necessary. For example, in conventional RFID tags, user identifications (Card IDs, or UIDs) are often 4-10 bytes in size, which has possible values far exceeding the number of users for any site. Accordingly, in accordance with the present disclosure, the raw data of the user identification (Card ID) is truncated by the controller 300 to either 8 or 16 bits, depending on the number of cardholders at the site, as shown in FIG. 2.

When card data is processed, the system generates 2002 the Derived ID by truncating the card data into a smaller, more manageable size. This Derived ID is then associated 2003 with the original user identification (Card ID) both at the controller 300 and at the wireless access point 200. Preferably, the Card ID is algorithmically truncated, for example by selecting a predetermined 8 or 16 bits of the Card ID, and then verifying them for uniqueness. However, in different embodiments of the system, a unique Derived ID could be randomly or sequentially assigned to a particular Card ID, and then stored in the access control database 320 of the system controller 300 and the local access schedule database 250 of the wireless access point 200. The Derived ID is essentially local to the access control system 100 of this embodiment of the present disclosure.

Initially, the full card data is synchronised by transmission 2004 between the gateway 310 of the controller and the wireless access point 200. This synchronisation process, though relatively energy-intensive (compared to other transmissions utilised by the system 100), happens infrequently-for example, only during the initial setup or when changes occur and new users or cards are added, or users are assigned to different cards.

Once synchronisation is accomplished, and the derived ID is stored 2005 in the data structure 250 on access point 200, all subsequent communication between the controller 300 and the access point 200 can be conducted using the Derived ID instead of the full card data. Because the Derived ID is significantly smaller, it requires less bandwidth and power to transmit, making the communication process much more efficient. The system 100 conserves energy by only requiring full data synchronization seldomly. In most cases, the smaller Derived ID is sufficient for the lock to process access permissions and other related tasks, thereby reducing the frequency and energy cost of data transmissions.

In essence, the Derived ID is a strategic innovation that enables the system to tag and manage a small, efficient data value (the Derived ID) to represent a much larger, complex one (the full card data). This approach optimizes the use of available wireless network resources and extends the battery life of the devices involved, making the overall access control system more reliable and cost-effective.

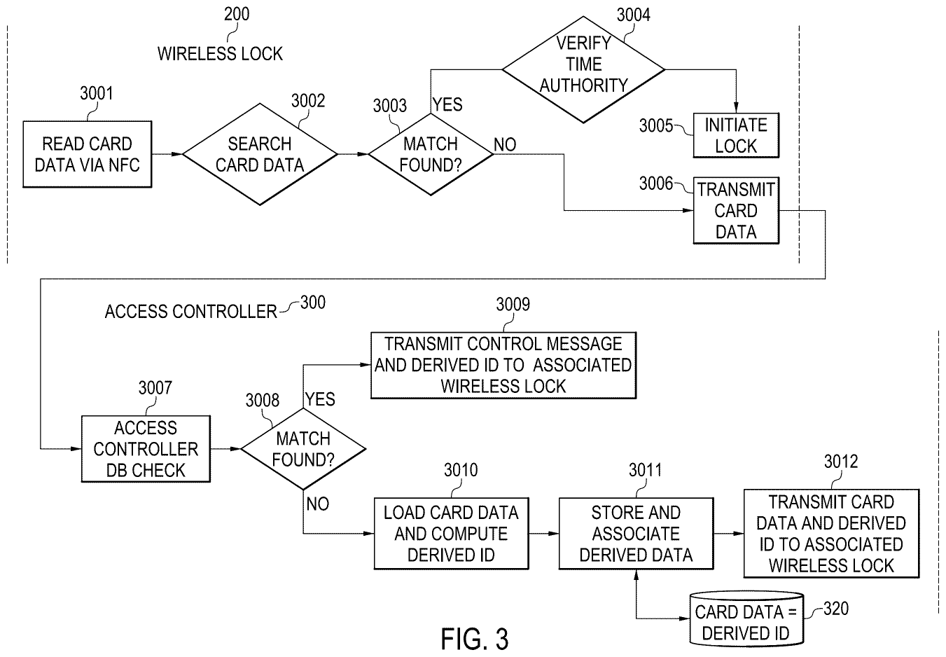

Accordingly, with reference to FIG. 3, when the reader 230 reads 3001 a user identification from card data, at the wireless access point 200, the full user identification can be searched 3002 in the local access schedule data structure. If a match is found 3003, the wireless lock control module can verify 3004 whether the requesting user has present time authority to pass through the access point. If the requesting user is authorised, the processor of the wireless access point 200 can then initiate 3005 the electro-mechanical lock to allow access, without requiring any data transmission to the controller.

If a match is not found, the wireless access point 200 can transmit 3006 the full user identification via the radio transceiver 210 to the access controller 300.

The access controller can then check 3007 the card data in its access controller database 320. If it finds a match 3008, and the access controller database 320 contains the user identification, the access controller 300 will respond 3009 to the wireless access point 200 with a control message and the associated Derived ID. The wireless access point 200 then stores the user identification and the associated Derived ID in its local data structure, for ongoing use.

If a match is not found, the controller 300 can then load the card data and compute 3010 a derived ID for that card. The associated derived ID is then stored 3011 in the access controller database 320, and the card data and derived ID transmitted 3012 to the access point 200, for use in future transmissions for that card. Note that access will not be granted until an access schedule is created for that user.

In the context of the present disclosure, a “Forward Schedule” is a compressed and encoded message comprising access time zone data, sent at a time preceding an expected change in an authorised user's access status. By transmitting only the next scheduled change, the data size of transmissions is reduced compared to conventional systems, allowing for efficient use of a long-range, low data rate wireless link.

The forward access schedule data to be transmitted from the controller 300 to the lock 200 comprises the Derived ID and the Forward Schedule for a user. This forms a highly compressed and encoding schema packet. This packet is transmitted to the wireless lock over the long-range, low-power communication link. Despite the low data rate, and often highly limiting regulatory restrictions, this method means that the wireless access point 200 has the information needed to determine access permissions for a given user.

The Forward Schedule is a compressed data structure that represents the timing for when access permissions should begin and end within a 24-hour period. It is designed to streamline the process of granting access by focusing only on the information needed to control access at specific times, without the complexity of traditional schedules. Firstly, the Forward Schedule encapsulates a start time and a duration within a 24-hour period. For instance, if access should begin at 9 AM and end at 12 PM, the Forward Schedule would compress this information into a small data packet: one part representing the 9 AM start time, and another representing the 3-hour duration.

This method bypasses the need for more complex scheduling information, such as days of the week, holidays, or specific calendar periods, which are typically required in traditional access control systems.

Whilst the full access control database 320, utilised by the controller 300, might contain detailed and complex scheduling information for a credential holder, this does not all need to be transmitted to the wireless access point 200. Accordingly, the controller 300 simplifies this information down to the basic start and stop times that are encapsulated in the Forward Schedule. Only this simplified schedule is transmitted to the access point 200, resulting in a significant reduction in the amount of data that needs to be sent over the wireless network.

The Forward Schedule is preferably transmitted within the 24-hour period prior to when the access permissions are needed. For example, if a user requires access starting at 9 AM on a Tuesday, the Forward Schedule is preferably transmitted before midnight on Monday. Alternatively, if no access is required on a given day, the Forward Schedule for that day may not transmitted until the next day when access is needed. For instance, if access is required on Wednesday, the Forward Schedule would be sent on Tuesday to ensure the correct permissions are in place for Wednesday. Of course, in preferred embodiments, the Forward Schedule covers an ongoing schedule for a user, as explained in the structure of the Forward Schedule set out below.

An example of a Forward Schedule bit structure is set out below, setting out forward access schedule data for a user can efficiently encode a specific time and event (start/stop) within a week, incorporating an 8-bit mask for the days of the week, including a special day. It comprises 20 bits, as follows:
Bit 0: Start/Stop indicator (1 bit)
Bits 1-8: Day of the week (8 bits)
Bits 9-13: Hour of the day (5 bits)
Bits 14-19: Minutes (6 bits)

The start/stop indicator (1 bit) is simply a single bit indicating whether the encoded time in the forward access schedule data represents a “start” or “stop” event. A value of 1 represents a “start” event, and a value of 0 represents a “stop” event for the user's access schedule.

The Day of the Week (8 bits) is simply a bitmask to represent the days of the week, allowing the system to differentiate between specific days or combinations of days. The 8th bit is reserved for a special day. In this embodiment, each bit corresponds to a day of the week, starting with Sunday and ending with the special day:
00000001: Sunday
00000010: Monday
00000100: Tuesday
00001000: Wednesday
00010000: Thursday
00100000: Friday
01000000: Saturday
10000000: Special Day

By way of example, a value of 00001100 indicates Tuesday and Wednesday, while 10000000 represents the special day.

The Hour of the Day (5 bits) represent the hour of the day in a 24-hour format, ranging from 00:00 to 23:00:
00000: 00:00 (midnight)
00001: 01:00 (1 AM)
01011: 11:00 (11 AM)
10111: 23:00 (11 PM)
11000 to 11111: Reserved (possibly unused, as only 0-23 are required)

By way of example, a value of 01110 represents 14:00 (2 PM).

The Minutes (6 bits), being the final six bits of the message, represent the exact minute within the hour, allowing for minute-level precision:
000000: 00 minutes
000001: 01 minute
011110: 30 minutes
111011: 59 minutes
111100 to 111111: Reserved (possibly unused, as only 0-59 are required)

By way of example, a value of 101101 represents 45 minutes.

To provide an example of a full Forward Schedule for a particular user, a 20-bit sequence of:
1|00001100|01110|101101
would represent:
Event Type: Start (1)
Day: Tuesday and Wednesday (00001100)
Hour: 14:00 (01110)
Minutes: 45 minutes (101101)

When decoded by the processor of the wireless access point 200, the message represents the event: “Start access at 14:45 on Tuesday and Wednesday.” This information is transmitted in a forward access schedule data message of less than 4 bytes (and in fact less than 3 bytes, in this embodiment).

This information is transmitted along with a Derived ID, and the schedule data can then be saved in the locally stored schedule data structure 250 at the wireless access point 200.

This compact 20-bit structure allows for efficient and precise encoding of events within a weekly cycle, including a special day. By using just 20 bits, it supports a full range of days, hours, and minutes, making it ideal for digital systems that require low overhead and straightforward manipulation. The 8-bit day mask adds flexibility, enabling complex scheduling that can include any combination of days, including a reserved special day.

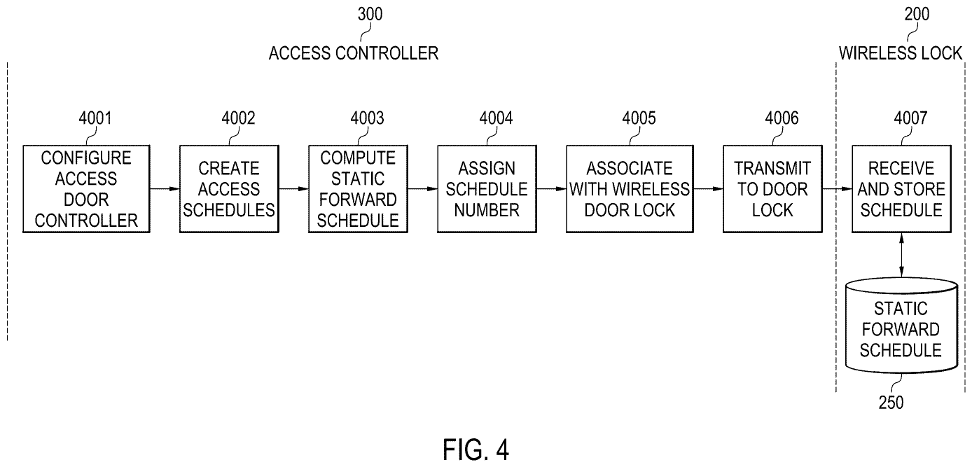

‘Static’ Forward Schedules and ‘Dynamic’ Forward Schedules may be used in different circumstances. FIG. 4 depicts the process of the controller 300 creating a Static Forward Schedule and transmitting it to the wireless access point 200. Initially, the controller 300 is configure 4001, and access schedules are created 4002.

For a Static Forward Schedule, the controller 300 can determine (from its full access schedule database 320) a combination of days of the week, start and stop times of the day, calendar days ranges and special days of the year. The controller 300 can analyse the complex access schedule and computer 4003 a highly efficient encoded data set called the Static Forward Schedule, for transmission to the wireless access point 200.

The controller 300 can assign 4004 and associate 4005 each Static Forward Schedules with a static schedule number, compute which Static Forward Schedules are associated with a given wireless access point 200, and transmit 4006 the associated Static Forward Schedules to the wireless access point 200. The access point 200 can then receive and store 4007 Static Forward Schedules, in its locally stored access schedule data structure 250.

For a Dynamic Forward Schedule, the controller can be configured with temporary access schedules. For example, a contractor may only be provided with access to a site (or part thereof) on a single day. Alternatively, a special one-off permission may be granted to specific user(s)—e.g. a user may ordinarily have 9 am-5 pm access on weekdays, but may be granted special access for 12 pm-3 pm on a particular weekend.

The controller 300 can be provided with this information, either from the access schedule database 320 or from an ad hoc input from a system administrator. The controller 300 can then compute a highly efficient encoded data set called the Dynamic Forward Schedule.

The controller 300 associates each Dynamic Forward Schedule with one or more Derived ID number associated with a temporary access state, computes which Dynamic Forward Schedules are associated with a given wireless access point 200, computes when the Dynamic Forward Schedules should be transmitted to the wireless access point 200, and then transmits the associated Dynamic Forward Schedules to the wireless access point 200 at the desired time (with the associated Derived ID(s)).

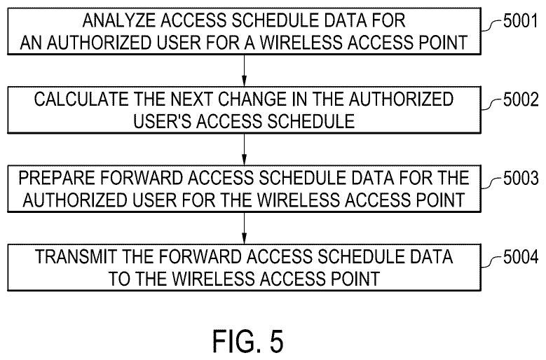

The general process is shown at a high level in FIG. 5. The controller 300 analyses schedule data for an authorised user for a wireless access point 200, and calculates 5002 the next change in the authorised user's access schedule. It then prepares 5003 the Forward Schedule, and transmits it 5004 to the relevant access point 200.

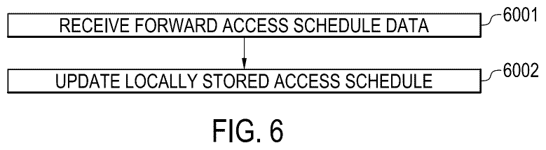

As shown in FIG. 6, the wireless access point 200 can then receive 6001 and store 6002 the Dynamic Forward Schedules, in its locally stored access schedule data structure 250 for the associated Derived ID.

The Forward Schedule is designed to drastically reduce the amount of data that needs to be transmitted between the controller 300 and the wireless access point 200. By focusing only on the essential start and end times for access permissions, the Forward Schedule eliminates the need for transmitting large, complex schedules. This results in reduced wireless bandwidth, lower energy consumption, and efficient and reliable access control. The Forward Schedule can provide a streamlined, efficient method for managing and transmitting access permissions in a wireless access control system, contributing to both reduced operational costs and enhanced system performance.

In the context of the present disclosure, a “Post Schedule” is a highly compressed and encoding schema representation of time and date, used to schedule the transmission of door events (e.g., access granted/denied) at a later time. This enables asynchronous communication, optimizes the 1% on-air duty cycle imposed by some regulatory bodies for long-range wireless communications, and allows for event bundling for increased efficiency.

When access events occur at a wireless access point, they are stored in an access event log at the wireless access point 200. The wireless access point 2000 can then determines the optimal time for transmission, considering duty cycle limitations and network congestion. At the determined transmission time, the access point 200 transmits a compressed data and encoding schema packet containing the Derived ID, event type, and Post Schedule to the access door controller. The access door controller 300 then decodes the packet, interprets the Post Schedule, and chronologically reconstructs the events from all locks.

The Post Schedule is a highly efficient or encrypted data structure used to log and transmit events such as door access or door force events. It is engineered to optimize data transmission, particularly in environments where wireless bandwidth is limited and power conservation is critical.

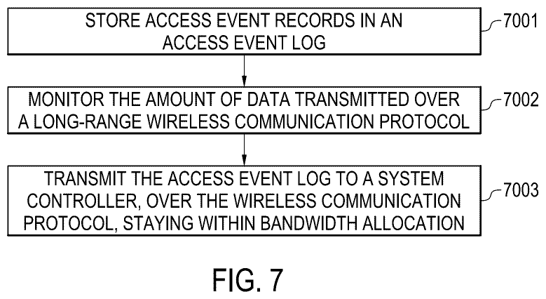

When an event occurs (e.g., a door is accessed or forced open), the access point 200, which is equipped with a real-time clock, records the exact time and date of the event internally. As depicted in FIG. 7, the event records are stored 7001 in an access event log (Post Schedule). However, this event is not immediately transmitted to the controller 300.

Instead of sending the full date and time of the event, the Post Schedule represents the event using a bit format. A single byte can represent up to eight different door conditions (e.g., access granted, door forced, etc.). Along with the event data, the Post Schedule includes a value that signifies the duration since the event occurred, rather than the actual date and time. This duration is what gets transmitted to the gateway 310 of the controller 300.

The access point 200 does not transmit events in real-time. Instead, it waits for an optimal time to send the data, typically when it can best utilize the 1% on-air duty cycle allowed for low-power wireless communication. Accordingly, it monitors 7002 data usage, and transmits 7003 the Post Schedule at a later time. This means that events are transmitted asynchronously (i.e. at a time distinct from the events themselves), and may be transmitted hours after they actually occur.

Once the controller's gateway 310 receives the event data and the Post Schedule, it deciphers the duration value provided by the Post Schedule. The controller 300 then uses this information to accurately index the event into its event log with the correct date and time.

By sending only the duration since the event occurred rather than the full date and time, the Post Schedule reduces the amount of data transmitted. This efficient transmission approach is important in environments with limited wireless bandwidth.

The delayed transmission of events, timed to optimize the 1% duty cycle, also helps the system comply with regulatory requirements while conserving battery life.

By way of explanation, for an event that occurs at a wireless access point 200:
Event will occur at the wireless access point 200.
The wireless access point 200 will store that event locally.
The wireless access point 200 will associate that event with a Post Schedule.
The wireless access point 200 will compute the most efficient time to transmit the event, and associated post Schedule, to the system controller 300.
The system controller 300 will receive the event and associated post Schedule from the wireless lock, and store the event and associated Post Schedule (e.g. in the global/master database 320).
The system controller 300 will index the event based on the Post Schedule time.

The above-described embodiment of the present disclosure provides numerous advantages over conventional systems. By employing long-range wireless technology, this embodiment allows the system to cover larger areas with fewer access door controllers, significantly reducing infrastructure costs. The use of low-power wireless technology and asynchronous event transmission also facilitates extended battery life for the wireless access points, reducing maintenance and operational costs. The compressed data structures (Derived ID, Forward Schedule, Post Schedule) enable efficient use of the low data rate link, ensuring reliable and timely access control and event reporting. Furthermore, the method adheres to regulatory restrictions, such as the 1% duty cycle, by minimizing the amount of data transmitted. Finally, the system supports autonomous operation, enhancing reliability, efficiency, and compatibility, and facilitating secure and efficient access control in various scenarios.

Concerning the computing devices used in various embodiments described in the present disclosure, each computing device will typically include a processor in communication with a memory. The computing device can also include one or more communication interfaces, in communication with the processor and/or memory, capable of sending and receiving data. In several embodiments, the memory is any form of storage storing a variety of data, including, but not limited to, instructions, transaction data, blockchain data, user data and/or machine classifiers. In many embodiments, instructions, the data may be stored using an external server system and received by the computing device using the communications interface.

The processor can include one or more physical processors communicatively coupled to memory devices, input/output devices, and the like. In one illustrative example, a processor may implement a Von Neumann architectural model and may include an arithmetic logic unit (ALU), a control unit, and a plurality of registers. In many aspects, a processor may be a single core processor that is typically capable of executing one instruction at a time (or process a single pipeline of instructions) and/or a multi-core processor that may simultaneously execute multiple instructions. In a variety of aspects, a processor may be implemented as a single integrated circuit, two or more integrated circuits, and/or may be a component of a multi-chip module in which individual microprocessor dies are included in a single integrated circuit package and hence share a single socket. Memory, typically provided on each device, can include a volatile or non-volatile memory device, such as RAM, ROM, EEPROM, or any other device capable of storing data. Communication devices can include network devices (e.g., a network adapter or any other component that connects a computer to a computer network).

In an embodiment, the system is a tangible, non-transitory, machine-readable medium storing instructions that when executed by one or more processors effectuate operations as described in this specification.

Although specific architectures for computing devices per embodiments of the invention are described above, any of a variety of architectures, including those that store data or applications on disk or some other form of storage and are loaded into memory at runtime, can also be utilised. Additionally, any of the data utilised in the system can be cached and transmitted once a network connection (such as a wireless network connection via the communications interface) becomes available. In several aspects, each computing device provides an interface, such as an API or web service, which provides some or all the data to other computing devices for further processing. Access to the interface can be open and/or secured using any of a variety of techniques, such as by using client authorisation keys, as appropriate to the requirements of specific applications of the disclosure. In a variety of embodiments, a memory includes circuitry such as, but not limited to, memory cells constructed using transistors, that store instructions. Similarly, a processor can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilising both general-purpose computing hardware and by single-purpose devices.

The foregoing provides one example of an embodiment of the present disclosure. However, numerous variations are possible. The present disclosure can also be implemented in numerous ways, including as processes, apparatus, systems, or (non-transitory) computer readable media.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. An access control system comprising:
a system controller; and
a wireless access point,
wherein the system controller is configured to:
identify and analyse changes in a locally stored access schedule for the wireless access point; and
in response to a detected change meeting certain criteria transmit a forward access schedule data packet to the wireless access point,
and wherein the wireless access point is configured:
in response to receiving the forward access schedule data packet from the system controller, update the locally stored access schedule data structure.

2. The access control system of claim 1, wherein the wireless access point comprises:
at least one wireless receiver to receive data over the wireless communication protocol, including the forward access schedule data packet;
a locally stored schedule data structure, storing the locally stored access schedule for authorised users at the wireless access point; and
a processor configured to receive and update the locally stored access schedule data structure in response to receiving the forward access schedule data packet.

3. The access control system of claim 2, wherein the wireless access point further comprises a reader to read a user identification of a requesting user, and wherein the processor of the wireless access point is further configured to compare the user identification to the access schedule in the locally stored schedule data structure, to determine whether to permit access to the requesting user.

4. The access control system of claim 3, wherein the wireless access point further comprises a lock having a locked state and an unlocked state, and wherein the processor of the wireless access point is further configured to set the lock to the unlocked state based on permitted access of the associated user.

5. The access control system of claim 3, wherein the locally stored access schedule in the locally stored schedule data structure comprises a schedule of time periods during which each authorised user is permitted access, and wherein determining whether to permit access to the requesting user comprises:
determining a current time; and
checking the locally stored access schedule for the requesting user at the current time.

6. The access control system of claim 1, wherein the forward access schedule data packet is transmitted and received in a compressed form.

7. The access control system of claim 1, wherein the forward access schedule data packet comprises:
a derived ID to identify an associated authorised user; and
a forward user schedule encoding a change in permitted access times for the associated authorised user.

8. The access control system of claim 7, wherein the forward user schedule comprises:
a start or stop indicator; and
a time indicator specifying particular access times, whereby the forward user schedule indicates whether access for the association authorised user starts or stops at the particular times.

9. The access control system of claim 8, wherein the start or stop indicator comprises a single bit.

10. The access control system of claim 8, wherein the time indicator comprises a bit mask representing days of the week, an hour indicator, and a minute indicator.

11. The access control system of claim 7, wherein the derived ID is a unique ID for the associated user, which is shorter than the user identification read by the reader.

12. The access control system of claim 3, wherein the reader comprises a short-range wireless reader.

13. The access control system of claims 2, wherein the wireless access point further comprises a wireless transmitter to transmit data over the wireless communication protocol, and wherein the processor of the wireless access point is configured to monitor the amount of data transmitted over the long-range wireless communication protocol to stay within a bandwidth allocation.

14. The access control system of claim 2, wherein the wireless access point further comprises a wireless transmitter to transmit data over the wireless communication protocol, and wherein the processor of the wireless access point is further configured to:
store access event records in an access event log; and
asynchronously transmit the access event log to the system controller, over the long-range wireless communication protocol.

15. (canceled)

16. The access control system of claim 13, wherein the bandwidth allocation is as low as 1% of airtime.

17. The access control system of claim 2, wherein the wireless communication protocol is a long-range wireless communication protocol.

18. The access control system of claim 2, wherein the wireless communication protocol is LoRA or SigFox.

19. (canceled)

20. The access control system of claim 1, wherein the system controller further comprises:
at least one wireless transmitter to transmit data over a wireless communication protocol, including the forward access schedule data packet;
an access control database defining an access schedule for authorised users at a plurality of access points; and
at least one processor configured to identify and analyse the changes in the locally stored access schedule for the wireless access point, and in response to the detected change meeting the certain criteria, transmit the forward access schedule data packet to the wireless access point.

21. (canceled)

22. (canceled)

23. (canceled)

24. (canceled)

25. (canceled)

26. (canceled)

27. (canceled)

28. The access control system of claim 20, wherein the system controller has a bandwidth allocation, and wherein the processor of the system controller is configured to monitor the amount of data transmitted over the long-range wireless communication protocol to stay within a bandwidth allocation.

29. The access control system of claim 28, wherein the bandwidth allocation is as low as 1% of airtime.

30. (canceled)

31. (canceled)

32. (canceled)

33. (canceled)

34. (canceled)

35. (canceled)

36. (canceled)

37. (canceled)

38. (canceled)
